(19) United States
(12) Patent Application Publication
(10) Pub. No.: US 2014/0165960 A1
(43) Pub. Date: Jun. 19, 2014

(54) VARIABLE INTAKE MANIFOLD FOR INTERNAL COMBUSTION ENGINE AND VARIABLE AIR INTAKE DEVICE USING THE SAME

(71) Applicants: Kia Motors Corporation, Seoul (KR); Hyundai Motor Company, Seoul (KR)

(72) Inventors: Dong Hee Han, Seoul (KR); Seung Kook Han, Suwon-si (KR); Hyun Jun Lim, Incheon (KR); Dong Ho Chu, Ansan-si (KR); Yoon Joo Kim, Yongin-si (KR); Ji Ho Kim, Seoul (KR); Hyuk Im, Suwon-si (KR); Jong Il Park, Seoul (KR)

(73) Assignees: Kia Motors Corporation, Seoul (KR); Hyundai Motor Company, Seoul (KR)

(21) Appl. No.: 14/020,433

(22) Filed: Sep. 6, 2013

(30) Foreign Application Priority Data
Dec. 17, 2012 (KR) 10-2012-0147808

(51) Int. Cl. F02B 31/04; F02B 31/06

(52) U.S. Cl. CPC F02B 31/04; F02B 31/06
USPC 123/306

(57) ABSTRACT

A variable intake manifold apparatus for an internal combustion engine, may include an inlet drawing in outside air and being connected to a main passage, first and second outlets branched from the main passage and fluid-connected to the inlet through the main passage and releasing the outside air drawn through the main passage through the first and second outlets, and a partition dividing the main passage and one of the first and second intake passages.

### CROSS-REFERENCE TO RELATED APPLICATION

The present application claims priority to Korean Patent Application No. 10-2012-0147808 filed on Dec. 17, 2012, the entire contents of which is incorporated herein for all purposes by this reference.

### BACKGROUND OF THE INVENTION

1. Field of the Invention

The present invention relates to a variable intake manifold for an internal combustion engine and a variable air intake device using the same, and more particularly, to a variable intake manifold for an internal combustion engine and a variable air intake device, which enhance tumble and swirl flows of intake air.

2. Description of Related Art

In general, a combustion chamber is formed in an internal combustion engine for directly injecting fuel for combustion by coupling a cylinder head to a cylinder block, and a piston is configured to reciprocate in the cylinder block to compress or expand the combustion chamber and vary the volume of the combustion chamber.

An intake port for introducing air into the combustion chamber and an exhaust port for emitting exhaust gases combusted in the combustion chamber are formed in the cylinder head, and an intake valve for opening and closing the intake port and an exhaust valve for opening and closing the exhaust port are installed in the cylinder head.

An injector for injecting fuel into the combustion chamber is installed in the cylinder head, adjacent to the intake port, and a spark plug for igniting the fuel injected by the injector is installed in the cylinder head.

By generating a tumble or swirl in the flow of intake air introduced to the combustion chamber from the thus-configured direct-injection internal combustion engine through the intake valve, incomplete combustion can be reduced due to an increase in combustion velocity, harmful components of exhaust gases can be reduced, as well as the output of the internal combustion engine can be improved, by increasing the inertia force of intake air during cold start and low-speed, low-load operation of the internal combustion engine, and the output of the internal combustion engine can be improved by increasing air intake efficiency during high-speed, high-load operation of the internal combustion engine.

As a conventional variable air intake device for generating a tumble flow or swirl flow of intake air, a so-called variable charge motion (VCM) valve device has been proposed.

The VCM valve device is typically installed in an intake manifold connected to the cylinder head so as to supply intake air to the intake port of the cylinder head, and includes a swirl control valve (SCV) for generating a swirl flow of intake air and a tumble control valve (TCV) for generating a tumble flow of intake air.

In the case of a four-valve internal combustion engine equipped with two intake valves and two exhaust valves, generally, a tumble flow is easily generated, while a swirl flow is not.

Moreover, while the tumble flow, for the most part, is decomposed into turbulent energy during a compression stroke, the swirl flow lasts longer than the tumble flow and increases turbulent energy until the expansion stroke of the internal combustion engine.

Accordingly, the conventional four-valve internal combustion engine is configured in such a manner that an intake flow becomes asymmetrical in order to generate a swirl flow of intake air, and to this end, one of the two intake ports is usually blocked by the VCM valve device.

Once one of the intake ports is blocked by the VCM valve device in order to generate a swirl flow of intake air, as described above, the strength of the tumble flow becomes less than that of the swirl flow. To make up for this, a VCM valve device has been proposed, which generates a strong tumble flow, as well as a swirl flow, by using an asymmetrical port flap valve to increase the tumble flow.

However, there has been suggested no way to achieve both a strong tumble flow and a strong swirl flow in the above-described conventional variable air intake device.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a variable intake manifold for an internal combustion engine and a variable air intake device using the same, which generate both strong tumble and swirl flows of intake air introduced into the combustion chamber of the internal combustion engine and continue to maintain high combustion velocity.

In an aspect of the present invention, a variable intake manifold apparatus for an internal combustion engine, may include an inlet drawing in outside air, first and second outlets releasing the outside air drawn through the inlet via different passages, and a partition dividing a part of a first intake passage extending from the inlet to the first outlet into an upstream passage and a part of a second intake passage extending from the inlet to the second outlet into a downstream passage, wherein the partition is of a different length in each of the first and second intake passages.

The partition may have a plate shape.

A main passage is formed to fluid-communicate the first and second intake passages with the inlet, wherein the first intake passage may have a smaller diameter than the main passage and extends from the main passage to the first outlet, and wherein the second intake passage may have a smaller diameter than the main passage and extend from the main passage to the second outlet.

The first intake passage and the second intake passage are branched at an acute angle from the main passage.

The first intake passage and the second intake passage are branched in a V-shape from the main passage.

The first intake passage and the second intake passage are of equal length.

The partition may include a main partition located only in the main passage, and an extended partition extending from the main partition to one of the first and second intake passages.

The main partition is provided up to an entrance of the other intake passage.

The partition is fixed to both sidewalls of the main passage and sidewalls of one of the intake passages.

In another aspect of the present invention, a variable air intake device for the internal combustion engine may include the variable intake manifold apparatus and a port flap valve device selectively opening the downstream passage partitioned off by the partition.

The port flap valve device may include a flap valve for opening and closing the downstream passage, and a rotary shaft integrally formed with the flap valve and, and selectively rotating the flap valve.

In further another aspect of the present invention, a variable intake manifold apparatus for an internal combustion engine, may include an inlet drawing in outside air and being connected to a main passage, first and second outlets branched from the main passage and fluid-connected to the inlet through the main passage and releasing the outside air drawn through the main passage through the first and second outlets, and a partition dividing the main passage and one of the first and second intake passages.

The variable intake manifold apparatus may further include a port flap valve device mounted in the inlet and selectively adjusting opening of the main passage.

According to the variable intake manifold and the variable air intake device using the same according to the exemplary embodiment of the present invention, a strong tumble flow and a strong swirl flow are simultaneously generated in the air entering the combustion chamber, thereby continuously maintaining high combustion velocity.

Moreover, the output of the internal combustion engine can be increased owing to improved air intake efficiency, by minimizing the flow resistance of intake air entering the combustion chamber through the intake manifold.

Furthermore, the emission of harmful exhaust gases can be reduced by preventing incomplete combustion by the improved air intake efficiency, and the assembly productivity can be improved because the structure is simple and an assembly deviation can be properly corrected.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partial cut-away front view of a variable intake manifold according to an exemplary embodiment of the present invention.

FIG. 2 is a side view of a variable air intake device according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

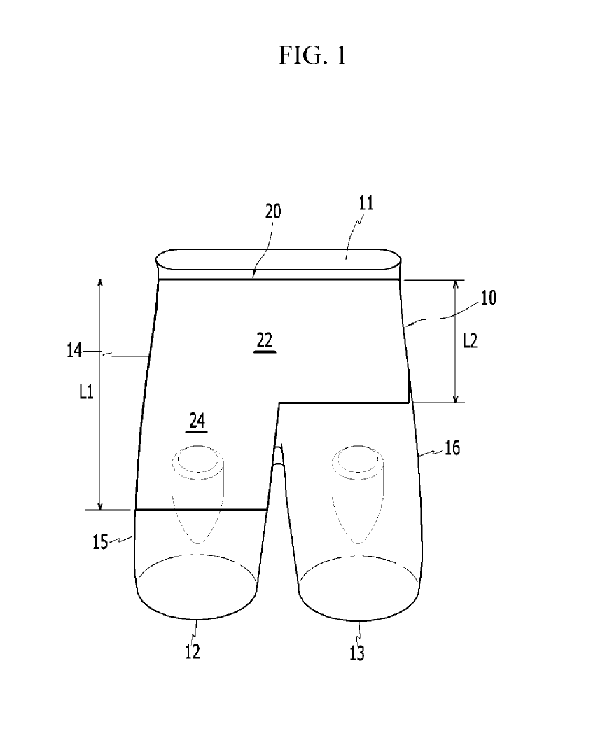

Referring to FIG. 1, a variable intake manifold 10 according to an exemplary embodiment of the present invention includes an inlet 11 for drawing outside air in and first and second outlets 12 and 13 for releasing the outside air.

A passage through which the outside air flows from the inlet 11 to the first and second outlets 12 and 13 is formed within the variable intake manifold 10.

The passage includes a main passage 14 having a substantially large diameter and communicating with the inlet 11, a first intake passage 15 extending from the main passage 14 to the first outlet 12 and having a smaller diameter than the main passage 14, and a second intake passage 16 extending from the main passage 14 to the second outlet 13 and having a smaller diameter than the main passage 14.

The first intake passage 15 and the second intake passage 16 are branched from the main passage 14 so as to form different intake passage from the main passage 14.

The first intake passage 15 and the second intake passage 16 are branched at an acute angle from the main passage 14.

The first intake passage 15 and the second intake passage 16 are branched in a substantially V-shape from the main passage 14.

The first intake passage 15 and the second intake passage 16 may be of equal length.

To divide part of the passage of the variable intake manifold into an upstream passage and a downstream passage, a partition 20 is inserted into the variable intake manifold.

The partition 20 has a substantially plate shape.

The partition 20 may be inserted into the variable intake manifold and fixed to both sidewalls facing each other.

The partition 20 includes a main partition 22 located only in the main passage 14 and an extended partition 24 extending from the main partition 22 to one of the intake passages, i.e., the first intake passage 15.

The main partition 22 may be provided only up to the entrance of the second intake passage 16.

The extended partition 24 may be extended not to the first intake passage 15, but to the second intake passage 16.

Accordingly, the length L1 of the partition 20 in the first intake passage 15 extending from the inlet 11 to the first outlet 12 via the first intake passage 15 is greater than the length L2 of the partition 20 in the second intake passage 16 extending from the inlet 11 to the second outlet 13 via the second intake passage 16.

Needless to say, the extended partition 24 may be located in the second intake passage 16 so that the length L2 of the partition in the second intake passage is greater than the length L1 of the partition in the first intake passage.

As stated above, first and second intake passages are formed within the variable intake manifold 10, the partition is configured to be of a different length in each intake passage, a strong tumble flow is generated in the flow of intake air via the intake passage (first intake passage) whose partition length is larger, and a strong swirl flow is generated in the flow of intake air via the intake passage (second intake passage) whose partition length is smaller.

Therefore, when intake air enters the combustion engine via the first and second intake passages, a strong tumble flow and a strong swirl flow are simultaneously introduced therein, thereby continuously maintaining high combustion velocity.

That is, the swirl flow is enhanced when the partition has a different length in each of the first and second intake passages, as compared to when the partition has an equal length. As a result, the turbulent intensity (tumble flow intensity+swirl flow intensity) of intake air is increased.

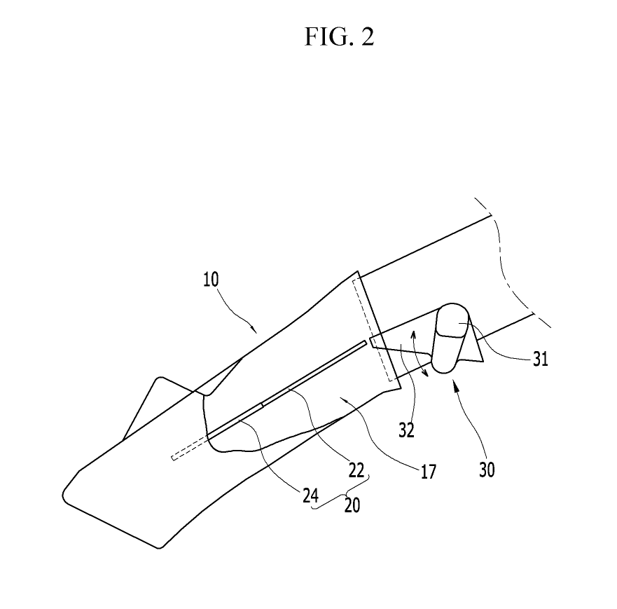

Referring to FIG. 2, a port flap valve deice 30 for opening and closing the downstream passage 17 partitioned off by the partition 20 is installed, after the partition 20 is installed in the variable intake manifold 10 in order to enhance tumble and swirl flows of intake air.

The port flap valve device 30 includes a rotary shaft 31 installed to rotate by driving means, such as a motor, and a flap valve 32 mounted to rotate integrally with the rotary shaft 31 to open and close the downstream passage 17.

An electron control unit ECU detects an operating state of the internal combustion engine, for example, a low-speed, low-load operating state of the internal combustion engine and a high-speed, high-load operating state thereof, and generates an appropriate control signal to drive the motor. Then, the rotary shaft 31 rotates in conjunction with the driving of the motor to rotate the flap valve 32, and the opening and closing degree of the downstream passage 17 is adjusted by the rotation of the flap valve 32, thus controlling the flow of intake air through the variable intake manifold 10.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A variable intake manifold apparatus for an internal combustion engine, comprising:
an inlet drawing in outside air;
first and second outlets releasing the outside air drawn through the inlet via different passages; and
a partition dividing a part of a first intake passage extending from the inlet to the first outlet into an upstream passage and a part of a second intake passage extending from the inlet to the second outlet into a downstream passage,
wherein the partition is of a different length in each of the first and second intake passages.

2. The variable intake manifold apparatus of claim 1, wherein the partition has a plate shape.

3. The variable intake manifold apparatus of claim 1,
wherein a main passage is formed to fluid-communicate the first and second intake passages with the inlet,
wherein the first intake passage has a smaller diameter than the main passage and extends from the main passage to the first outlet, and
wherein the second intake passage has a smaller diameter than the main passage and extends from the main passage to the second outlet.

4. The variable intake manifold apparatus of claim 3, wherein the first intake passage and the second intake passage are branched at an acute angle from the main passage.

5. The variable intake manifold apparatus of claim 3, wherein the first intake passage and the second intake passage are branched in a V-shape from the main passage.

6. The variable intake manifold apparatus of claim 3, wherein the first intake passage and the second intake passage are of equal length.

7. The variable intake manifold apparatus of claim 3, wherein the partition comprises:
a main partition located only in the main passage; and
an extended partition extending from the main partition to one of the first and second intake passages.

8. The variable intake manifold apparatus of claim 7, wherein the main partition is provided up to an entrance of the other intake passage.

9. The variable intake manifold apparatus of claim 8, wherein the partition is fixed to both sidewalls of the main passage and sidewalls of one of the intake passages.

10. A variable air intake device for the internal combustion engine, comprising:
the variable intake manifold apparatus of claim 1; and
a port flap valve device selectively opening the downstream passage partitioned off by the partition.

11. The variable air intake device of claim 10, wherein the port flap valve device comprises:
a flap valve for opening and closing the downstream passage; and
a rotary shaft integrally formed with the flap valve and, and selectively rotating the flap valve.

12. A variable intake manifold apparatus for an internal combustion engine, comprising:
an inlet drawing in outside air and being connected to a main passage;
first and second outlets branched from the main passage and fluid-connected to the inlet through the main passage and releasing the outside air drawn through the main passage through the first and second outlets; and
a partition dividing the main passage and one of the first and second intake passages.

13. The variable intake manifold apparatus of claim 12, further including a port flap valve device mounted in the inlet and selectively adjusting opening of the main passage.
